(19) United States
(12) Patent Application Publication
(10) Pub. No.: US 2026/0059279 A1
(43) Pub. Date: Feb. 26, 2026

(54) WHEEL MOUNTED INFORMATION TRANSFER SYSTEM FOR AUTONOMOUS VEHICLES

(71) Applicant: Torc Robotics, Inc., Blacksburg, VA (US)

(72) Inventors: Akshay Pai Raikar, Austin, TX (US); Hamzah Imtiaz Khan, Austin, TX (US); Joseph R. Fox-Rabinovitz, Austin, TX (US)

(21) Appl. No.: 18/810,193

(22) Filed: Aug. 20, 2024

(51) Int. Cl. H04W 4/44; B60W 40/105

(52) U.S. Cl. CPC H04W 4/44; B60W 40/105; B60W 2422/70; B60W 2556/45

(57) ABSTRACT

The present disclosure generally relates to systems and methods for a wheel mounted information transfer device. The wheel mounted device is configured to communicatively couple with a smart road sensor. The device is connected to an autonomy computing system comprising a processor connected to a memory storing computer executable instructions. The processor is configured to: receive, from the smart road sensor, sensor data corresponding to a rotation of a wheel connected to the wheel mounted device, the rotation of the wheel mounted device comprising: a first position of the device communicatively coupled with the smart road sensor, and a second position of the device communicatively coupled to the autonomous vehicle. The processor is further configured to compute a time interval between the first and the second position; modify a parameter of the sensor data transmitted to the autonomy computing system; and process the sensor data to operate the autonomous vehicle.

### TECHNICAL FIELD

The field of the disclosure relates generally to autonomous vehicles and, more specifically, systems and methods for information transfer between an autonomous vehicle and a smart road, particularly an autonomous vehicle including a wheel mounted device.

### BACKGROUND OF THE INVENTION

Autonomous vehicles rely on existing road infrastructure to transport goods from one location to another. Specifically, autonomous vehicles are designed to navigate from origin to destination without human intervention. However, as smart roads become more prevalent, there is a need to transfer data between the autonomous vehicle and the smart road. Smart roads conventionally utilize both passive and active sensors that interact with the autonomous vehicle. Accordingly, there is a need for a device to facilitate the communication between the smart road and the autonomous vehicle.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a method for information transfer between a wheel mounted device and a smart road is disclosed. The method also includes capturing smart road data from a smart road sensor when a wheel mounted device is at a first position, where at the first position the wheel mounted device is communicatively coupled with the smart road sensor. The method further includes transmitting the smart road data to an autonomy computing system when the wheel mounted device is in a second position, computing a time interval between the wheel mounted device being at the first position and the wheel mounted device being at the second position, and modifying a parameter of the smart road data for transmitting the smart road data to an autonomy computing system based on the computed time interval.

In another aspect, an autonomous vehicle disclosed. The autonomous vehicle includes a wheel mounted device. The wheel mounted device is configured to communicatively couple with a smart road sensor. The autonomous vehicle also includes an autonomy computing system. The autonomy computing system includes a processor connected to a memory storing computer executable instructions, the processor, upon executing the computer executable instructions, configured to: receive, from the smart road sensor, sensor data corresponding to a rotation of the wheel mounted device. The rotation of the wheel mounted device includes: a first position of the wheel mounted device communicatively coupled with the smart road sensor, and a second position of the wheel mounted device communicatively coupled to the autonomous vehicle. The processor is further configured to compute a time interval between the first position and the second position; modify a parameter of the sensor data transmitted to the autonomy computing system and process the sensor data to execute autonomous operation of the autonomous vehicle.

In yet another aspect, a smart road system for autonomous vehicles is disclosed. The autonomous vehicle includes a wheel mounted device; and the smart road includes a smart road sensor. The smart road is configured to receive a signal from the wheel mounted device upon communicative coupling of the wheel mounted device with the smart road sensor, where a parameter of the signal corresponds to an angular velocity of the wheel mounted device, identify the parameter of the signal from the wheel mounted device, and transmit smart road data corresponding to the smart road, where the parameter of the transmitted smart road data corresponds to the parameter of the received signal from the wheel mounted device.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3 is an illustration of the wheel mounted device on an autonomous vehicle;

FIG. 4A-B are illustration of the wheel mounted device coupling with the smart road and the autonomy computing system;

FIG. 5 is a flow diagram of one embodiment of a method of information transfer between a wheel mounted device and smart road; and

FIG. 6 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

The disclosed wheel mounted device facilitates smart road data capture and transmission between the autonomous vehicle and the smart road sensor. The wheel mounted device communicatively couples to a smart road sensor embedded within the smart road when the wheel is in a first position. The wheel mounted device transmits the smart road data to an autonomy computing system in a second position. In various embodiments, the wheel mounted device is mounted within the wheel of the autonomous vehicle. For example, the wheel mounted device is embedded within a rim of the wheel or a tire of the wheel. In other embodiments, the wheel mounted device is located on the hub of an axle of the autonomous vehicle for mounting to the wheel.

The smart road is a roadway including a plurality of smart road sensors. In some embodiments, the smart road sensor is embedded within the roadway. The smart road sensors are configured to identify the presence or absence of objects including, but not limited to, vehicles, pedestrians, or debris, etc. The smart road sensor is further configured to identify the presence of the wheel mounted device. For example, the smart road sensor may include a radio frequency identification (RFID) sensor. In various embodiments, the wheel mounted device communicatively couples with an additional smart road sensor as the autonomous vehicle travels along the smart road. The wheel mounted device is configured to capture additional sensor data from the smart road sensor as it communicatively couples to the additional smart road sensor.

For example, the smart road sensor is configured to receive a signal from the wheel mounted device upon communicative coupling of the wheel mounted device to the smart road sensor. The smart road sensor is also configured to identify a parameter from the signal such as an angular velocity of the wheel mounted device. Further, the smart road sensor is configured to transmit smart road data to the wheel mounted device based on the parameter from the received signal.

The wheel mounted device includes a processor coupled to a memory. The processor is configured to execute computer executable instructions stored on the memory. The wheel mounted device includes a wireless communication module to communicatively couple to the smart road and the autonomy computing system. The wireless communication module provides wireless vehicle-to-everything (V2X) communication to communicatively couple with the smart road and the autonomy computing system. In some embodiments, the wheel mounted device utilizes a first V2X protocol to communicatively couple to the smart road sensor and a second V2X protocol to transmit the smart road data to the autonomy computing system. In various embodiments, the V2X protocol is the same for the smart road and the autonomy computing system. For example, the wheel mounted device transmits a RF signal to the smart road sensor, which then responds with transmitting an RFID signal to the wheel mounted device.

In the first position, the wheel mounted device captures smart road data from a smart road sensor. The smart road data includes: location data, road condition information, traffic data, infrastructure information, navigation data, and safety data. In the second position, the wheel mounted device transmits the smart road data to the autonomy computing system. For example, the wheel mounted device communicatively couples to the autonomy computing system in the second position to transmit the smart road data to the autonomy computing system. In some embodiments, the second position of the wheel mounted device is closer to the autonomy computing system than the first position of the wheel mounted device.

The autonomy computing system computes a time interval based on the smart road data. The computed time interval is computed between the first position of the wheel mounted device and the second position of the wheel mounted device. In other embodiments, the time interval is computed based on successive revolutions of the wheel mounted device at either the first position or the second position.

In various embodiments, the computed time interval is utilized to compute a modification for a parameter of the smart road data transmission to the autonomy computing system. For example, a packet size of the transmitted smart road data is modified based on the computed time interval. In other embodiments, sensor verification is modified based on the computed time interval. Further, the smart road data is processed to compute the speed of the autonomous vehicle.

In various embodiments, an updated time interval is computed when the wheel mounted device communicatively couples with an additional smart road sensor. In various embodiments, the autonomy computing system updates the parameters for transmission of the smart road data to the autonomy computing system based on the updated time interval. For example, when the updated time interval decreases, the frequency of the smart road sensor data verification increases. Additionally, the packet size of the sensor data also decreases as the updated time interval decreases. Alternatively, sensor data verification decreases and packet size increases as the updated computed time interval increases.

In various embodiments, the autonomy computing system modifies a parameter of the sensor data transmitted to the autonomy computing system from the wheel mounted device. For example, the time interval between the wheel mounted device being at the first position and being at the second position is computed to modify a parameter of the sensor data transmitted to the autonomy computing system. In other embodiments, the modification can be made based on the time interval between successive revolutions of the wheel mounted device at either the first position or the second position. In some embodiments, the parameter corresponds to an angular velocity of the wheel mounted device.

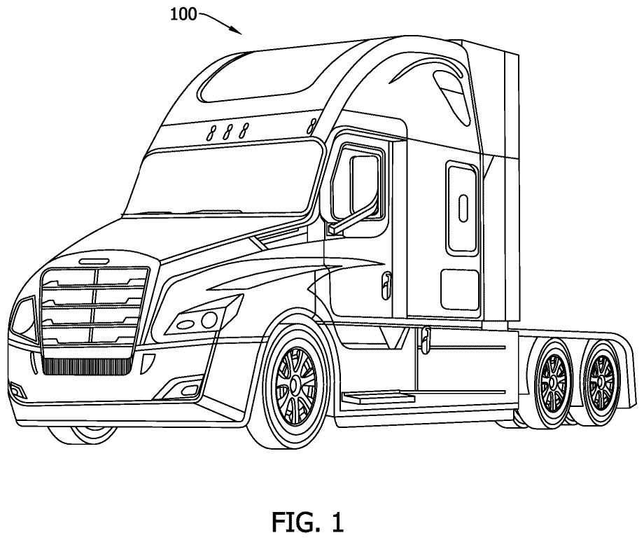

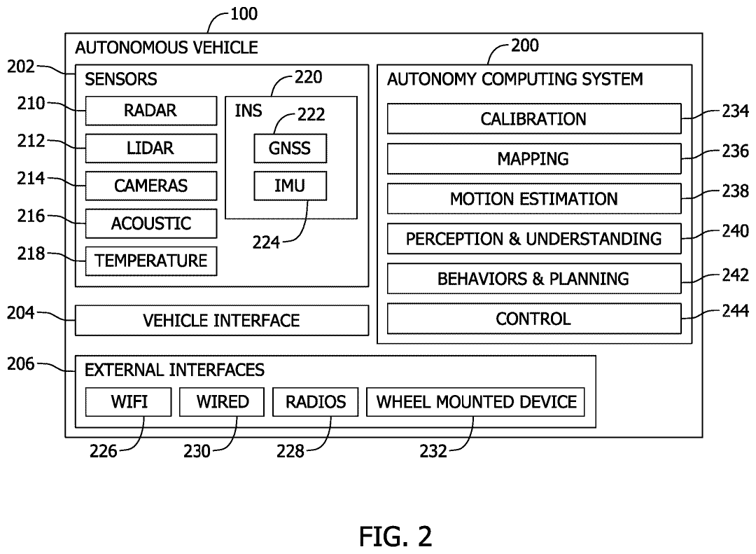

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras'FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 230, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In various embodiments, the autonomous vehicle 100 includes a wheel mounted device 232. The wheel mounted device 232 includes a processor coupled to a memory mounted within a wheel of the of the autonomous vehicle 100. For example, the wheel mounted device 232 is embedded with a rim of the wheel or a tire of the wheel. In other embodiments, the wheel mounted device is located on the hub of an axle of the autonomous vehicle 100. The wheel mounted device is configured to facilitate data capture and transmission to the autonomy computing system 200. For example, the wheel mounted device 232 captures and transmits smart road data to the autonomy computing system 200. In the depicted embodiment, the wheel mounted device 232 is part of external interfaces 206. In some embodiments, the wheel mounted device 232 is independent from external interfaces 206.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 234, a mapping module 236, a motion estimation module 238, a perception and understanding module 240, a behaviors and planning module 242, a control module or controller 244. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

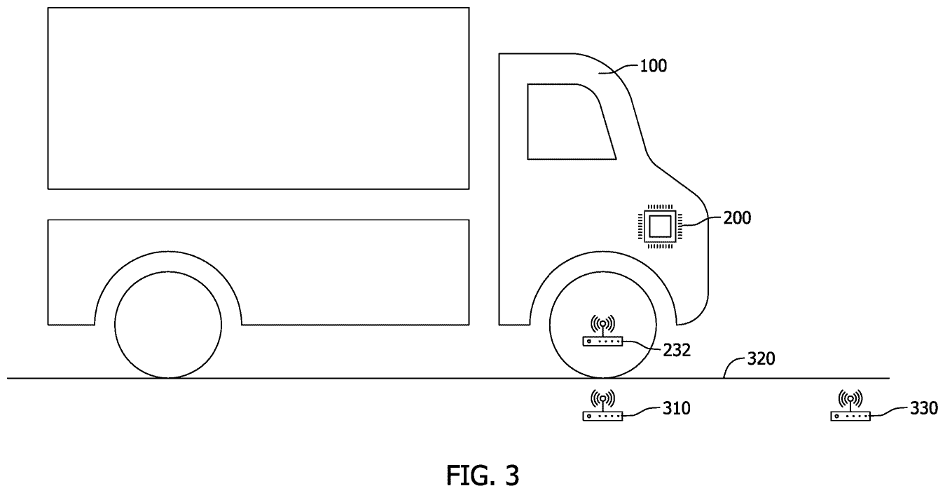

FIG. 3 is an illustration of the wheel mounted device 232 on an autonomous vehicle 100. The wheel mounted device 232 is configured to communicatively couple to a smart road sensor 310 embedded within a smart road 320. Additionally, the wheel mounted device 232 communicatively couples to the autonomy computing system 200 to transmit smart road data to the autonomy computing system 200. In some embodiments, as the autonomous vehicle 100 travels along the smart road 320, the wheel mounted device 232 communicatively couples with an additional smart road sensor 330.

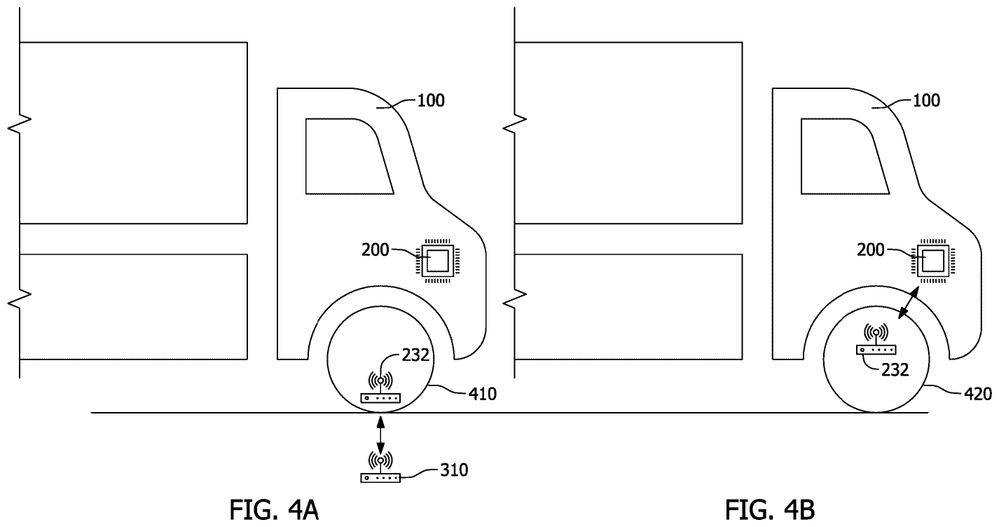

FIG. 4A-B are illustration of the wheel mounted device 232 as it rotates between the first position 410 and the second position 420. FIG. 4A illustrates the wheel mounted device 232 located in a first position 410 where the wheel mounted device 232 is communicatively coupled with a smart road sensor 310. FIG. 4B illustrates the wheel mounted device 232 located in a second position 420 where the wheel mounted device 232 transmits the smart road data to the autonomy computing system 200.

In the first position 410, the wheel mounted device 232 is communicatively coupled to the smart road sensor 310 to capture smart road data. In various embodiments, the smart road data includes location data, road condition information, traffic data, infrastructure information, navigation data, and safety data. In some embodiments, the smart road data is processed to determine a speed of the autonomous vehicle 100. In some embodiments, the smart road sensor is a RFID sensor and the wheel mounted device 232 communicatively couples to the smart road sensor 310 by transmitting an RF signal to the smart road sensor 310. The wheel mounted device 232 then receives an RFID signal in response from the smart road sensor 310.

In the second position 420, the wheel mounted device 232 transmits the smart road data to the autonomy computing system 200. In various embodiments, the autonomy computing system 200 computes a time interval between the wheel mounted device 232 being located at the first position 410 and being located at the second position 420. In other embodiments, the time interval is computed based on the time interval between successive revolutions of the wheel mounted device 232 at either the first position 410 or the second position 420.

In various embodiments, a parameter of the smart road data transmitted to the autonomy computing system 200 is modified based on the computed time interval. The modified parameter includes a smart road data verification parameter and a smart road data packet size. For example, the frequency of the smart road data verification increases if the computed time interval is below a predetermined threshold. In various embodiments, the threshold is a predetermined time interval. Further, the packet size of the smart road data decreases if the smart road data is below the threshold.

In some embodiments, as the autonomous vehicle travels along the smart road, the wheel mounted device 232 captures additional smart road data from an additional smart road sensor 330 on the smart road 320. An updated time interval is computed based on the communicative coupling of the wheel mounted device 232 and the additional smart road sensor 330. In various embodiments, the parameter is modified based on the updated time interval including modifying the packet size of the smart road data or modifying the smart road data verification.

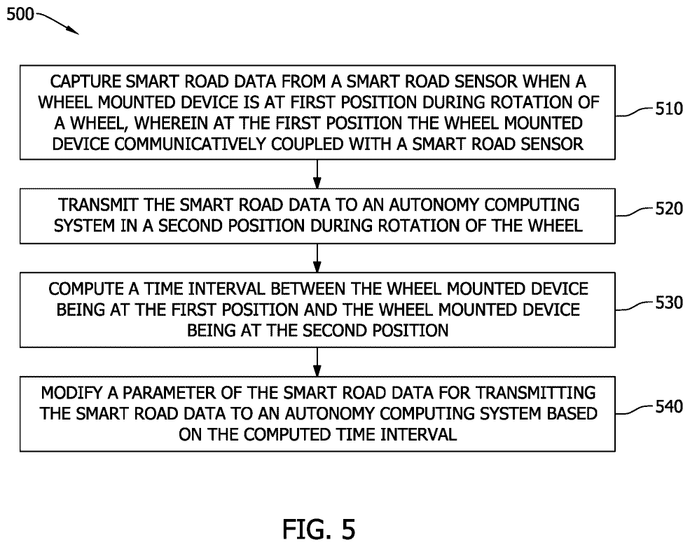

FIG. 5 is a flow diagram of one embodiment of a method 500 of information transfer between a wheel mounted device 232 and a smart road sensor 310. Method 500 includes capturing 510 smart road data from a smart road sensor 320 when the wheel mounted device 232 is at a first position 410 during the rotation of the wheel where the wheel mounted device 232 is communicatively coupled to the smart road sensor 310. For example, the wheel mounted device 232 transmits and RF signal to the smart road sensor 310. The wheel mounted device 232 then receives a RFID signal from the smart road sensor 310 in response to capturing the smart road data. Method 500 further includes transmitting 520 the smart road data to an autonomy computing system 200 in a second position 420 of the wheel mounted device 232. Method 500 also includes computing 530 a time interval between the wheel mounted device 232 at the first position 410 and the second position 420. Additionally, method 500 includes modifying 540 a parameter of the smart road data for transmitting the smart road data to an autonomy computing system based on the computed time interval. In various embodiments, modifying 540 the parameter includes changing the data verification for the smart road data. Modifying 540 the smart road data also includes changing the packet size transmitted from the wheel mounted device 232 to the autonomy computing system 200. Method 700 may include additional, fewer, or alternative steps.

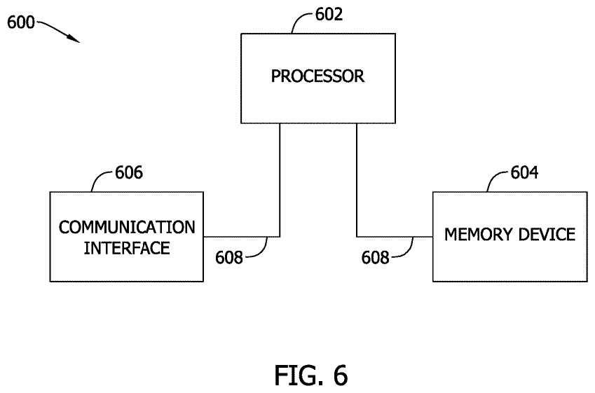

FIG. 6 is a block diagram of an example computing device 600. Computing device 600 includes a processor 602 and a memory device 604. The processor 602 is coupled to the memory device 604 via a system bus 608. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor. ”

In the example embodiment, the memory device 604 includes one or more devices that enable information, such as executable instructions or other data (e.g., sensor data), to be stored and retrieved. Moreover, the memory device 604 includes one or more computer readable media, such as, without limitation, dynamic random access memory (DRAM), static random access memory (SRAM), a solid state disk, or a hard disk. In the example embodiment, the memory device 604 stores, without limitation, application source code, application object code, configuration data, additional input events, application states, assertion statements, validation results, or any other type of data. The computing device 600, in the example embodiment, may also include a communication interface 606 that is coupled to the processor 602 via system bus 608. Moreover, the communication interface 606 is communicatively coupled to data acquisition devices.

In the example embodiment, processor 602 may be programmed by encoding an operation using one or more executable instructions and providing the executable instructions in the memory device 604. In the example embodiment, the processor 602 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A method for information transfer between a wheel mounted device and a smart road, the method comprising:
capturing smart road data from a smart road sensor when a wheel mounted device is at a first position, wherein at the first position the wheel mounted device is communicatively coupled with the smart road sensor;
transmitting the smart road data to an autonomy computing system when the wheel mounted device is in a second position;
computing a time interval between the wheel mounted device being at the first position and the wheel mounted device being at the second position; and
modifying a parameter of the smart road data for transmitting the smart road data to an autonomy computing system based on the computed time interval.

2. The method of claim 1, further comprising capturing additional smart road data upon the communicative coupling of the wheel mounted device with an additional smart road sensor.

3. The method of claim 2, further comprising computing an updated time interval between the communicative coupling of the wheel mounted device with the smart road sensor and the additional smart road sensor.

4. The method of claim 3, wherein modifying the parameter further comprises increasing smart road data verification in response to a decrease in the updated computed time interval or decreasing packet size of the smart road data in response to the decrease in the updated computed time interval.

5. The method of claim 2, further comprising updating the parameter of the additional smart road data for transmission to the autonomy computing system.

6. The method of claim 1, wherein capturing the smart road data comprises transmitting a RF signal to the smart road sensor and receiving an RFID signal response from the smart road sensor.

7. The method of claim 1, further comprising processing the smart road data to determine a speed of an autonomous vehicle.

8. An autonomous vehicle comprising:
a wheel mounted device on the autonomous vehicle, the wheel mounted device configured to communicatively couple with a smart road sensor; and
an autonomy computing system comprising a processor connected to a memory storing computer executable instructions, the processor, upon executing the computer executable instructions, configured to:
receive, from the smart road sensor, sensor data corresponding to a rotation of the wheel mounted device, the rotation of the wheel mounted device comprising:
a first position of the wheel mounted device communicatively coupled with the smart road sensor, and
a second position of the wheel mounted device communicatively coupled to the autonomous vehicle;
computing a time interval between the first position and the second position;
modify a parameter of the sensor data transmitted to the autonomy computing system; and
process the sensor data to execute autonomous operation of the autonomous vehicle.

9. The autonomous vehicle of claim 8, wherein the processor is further configured to capture additional smart road data upon the communicative coupling of the wheel mounted device with an additional smart road sensor.

10. The autonomous vehicle of claim 9, wherein the processor is further configured compute an updated time interval between the communicative coupling of the wheel mounted device with the smart road sensor and the additional smart road sensor.

11. The autonomous vehicle of claim 10, wherein the autonomy computing system is further configured to increase sensor data verification in response to a decrease in the time interval.

12. The autonomous vehicle of claim 9, wherein the processor is further configured to update the parameter of the additional smart road data for transmission to the autonomy computing system.

13. The autonomous vehicle of claim 8, wherein the wheel mounted device is mounted within the wheel of the autonomous vehicle.

14. The autonomous vehicle of claim 8, further comprising an additional wheel mounted device on an additional wheel of the autonomous vehicle.

15. A smart road system for autonomous vehicles, the system comprising:
an autonomous vehicle, the autonomous vehicle comprising a wheel mounted device; and
a smart road comprising a plurality of smart road sensors, the smart road configured to:
receive a signal from the wheel mounted device upon communicative coupling of the wheel mounted device with the smart road sensor, wherein a parameter of the signal corresponds to an angular velocity of the wheel mounted device;
identify the parameter of the signal from the wheel mounted device; and
transmit smart road data corresponding to the smart road, wherein the parameter of the transmitted smart road data corresponds to the parameter of the received signal from the wheel mounted device.

16. The system of claim 15, wherein the smart road is further configured to receive an additional signal from the wheel mounted device upon the communicative coupling of the wheel mounted device with an additional smart road sensor.

17. The system of claim 16, wherein the smart road is further configured to update the parameter of the signal from an additional communicative coupling of the wheel mounted device with the additional smart road sensor.

18. The system of claim 15, wherein the smart road sensor is an RFID sensor.

19. The system of claim 15, wherein the wheel mounted device is embedded within a tire connected to the wheel.

20. The system of claim 15, wherein the smart road sensor is embedded within the smart road.
